(19) United States
(12) Patent Application Publication
(10) Pub. No.: US 2002/0115407 A1
(43) Pub. Date: Aug. 22, 2002

(54) Wireless ASP systems and methods

(75) Inventors: David Thompson, Austin, TX (US); James Chou, Austin, TX (US)

Correspondence Address: H. Dale Langley, Jr., The Law Firm of H. Dale Langley, Jr., P.C., 610 West Lynn, Austin, TX, 78703, US

(73) Assignee: BroadCloud Communications, Inc.

(21) Appl. No.: 09/982,509

(22) Filed: Oct. 17, 2001

Related U.S. Application Data
(63) Continuation-in-part of application No. 08/852,557, filed on May 7, 1997, now Pat. No. 6,166,729.
(60) Provisional application No. 60/241,096, filed on Oct. 17, 2000.
(60) Provisional application No. 60/177,329, filed on Jan. 21, 2000.
(60) Provisional application No. 60/180,649, filed on Feb. 7, 2000.
(60) Provisional application No. 60/220,730, filed on Jul. 26, 2000.
(60) Provisional application No. 60/241,095, filed on Oct. 17, 2000.
(60) Provisional application No. 60/241,087, filed on Oct. 17, 2000.
(60) Provisional application No. 60/240,985, filed on Oct. 17, 2000.
(60) Provisional application No. 60/240,986, filed on Oct. 18, 2000.

(51) Int. Cl. H04H 1/00; H04N 7/16

(52) U.S. Cl. 455/3.01; 725/62; 455/3.05

(57) ABSTRACT

A communications service provider provides wireless access to a packetized data network, such as the Internet. The service provider includes a server computer. The server computer is connected to the network, which is at least in part a wired network. The wired network is connected to a cellular wireless communications system. Features of the network and the server computer include group messaging, co-processors, dynamic protocol dictionaries, and cache synchronization and optimization. The features speed and improve communications over the network, including over wireless channels and dynamic conditions of those channels.

### CROSS-REFERENCE TO RELATED APPLICATIONS

The present application is a continuation-in-part of U.S. patent application Ser. No. 08/852,557, and is also related to U.S. patent application (CPA) Ser. No. 08/852,557, entitled “Remote Digital Image Viewing System and Method”, filed May 7, 1997 (CPA filed Oct. 26, 1999); U.S. Provisional Patent Application No. 60/177,329, entitled “Wireless Network System and Method”, filed Jan. 21, 2000; U.S. Provisional Patent Application No. 60/180,649, entitled “Digital Image Transfer System and Method”, filed Feb. 7, 2000; and U.S. Provisional Patent Application No. 60/220,730, entitled “Wireless Network System and Method”, filed Jul. 26, 2000, each of the same inventor thereof, and those respective applications are incorporated herein. The present application is also related to U.S. Provisional Patent Application No. 60/541,086, entitled “Wireless Communications Invisible Proxy and Hooking Systems and Methods,” filed Oct. 16, 2000, U.S. Provisional Patent Application No. 60/241,095, entitled “E-Mail and Messaging Systems and Methods,” filed Oct. 16, 2000, U.S. Provisional Patent Application No. 60/241,087, entitled “Wireless Communications Protocols and Architectures Systems and Methods,” filed Oct. 16, 2000, and U.S. Provision Patent No. 60/240,985, entitled “Browser and Network Optimization Systems and Methods,” filed Oct. 16, 2000.

### BACKGROUND OF THE INVENTION

The present invention generally relates to communications systems and methods and, more particularly, relates to wireless application service provider networks and systems and methods therefor.

Wireless data communications are becoming increasingly common. For example, certain cellular telephones can presently receive and display limited textual content. Some pagers presently have limited text messaging capabilities. Wireless modems can equip computing devices, such as laptop computers, personal digital assistants, and the like, for communicating over networks, such as the Internet, through wireless channels.

Application service providers (ASPs) are companies that offer remote access over networks, such as the Internet, to application programs and other services. These providers operate server computers that communicate over the network with remote and disparate order to client computers. The server computers maintain for, or otherwise permit access to, client computers certain and various applications and services that would otherwise have to be located on the client computers in order for the client computers to run or operate the programs or services. In wireless communications networks, application service providers (ASPs) can provide to client computers access to various programs and services that are not necessarily saved or processed by the client computers.

ASP services are particularly desirable with wireless computing devices because those devices typically are less robust, efficient, and speedy than larger enterprise server computers. Wireless devices, operating in connection with an ASP for more demanding processing and features, can serve many functions and supply capabilities that would otherwise require added equipment and complexity of the wireless devices. In a network that is at least in part wireless and comprised of disparate and remote wireless devices, client devices can access the ASP server devices through wireless channels and obtain benefits of the greater computing power and capabilities of the server devices.

Although wireless client devices can communicate with ASP servers to provide added functionality and capabilities not present at the wireless clients, certain applications and services that may be provided by the ASP are not optimal. This is particularly the case because of the problems and limitations inherent in wireless communications. Additionally, other aspects of wireless networks, as well as ASP services in general, have not generally been designed or enabled with a view to wireless ASP application.

It would be a significant improvement in the art and technology to provide improved wireless ASP systems and methods for packetized data network communications over the Internet and other networks.

### SUMMARY OF THE INVENTION

An embodiment of the invention is a wireless communications network. The network includes a wired network, a wireless channel, a wireless application service provider server computer connected to the wired network, a wireless packetized data communications provider equipment connected to the wired network, a first client device communicatively connected via the wireless channel to the wireless packetized data communications provider, and a second client device communicatively connected to the network. In certain embodiments, a detector determines a first location of the first client device and a second location of the second client device. A server associates the respective location with the respective client device. The network enables messaging between client devices based on the respective locations.

Another embodiment of the invention is a method of wireless communications. A first client device has a first location and a second client device has a second location. The method includes serving a first information indicative of the first location to the second client device, serving a second information indicative of the second location to the first client device, and enabling, by virtue of the first information and the second information, the first client device to communicate with the second client device. In certain embodiments, the serving steps include relating the respective locations with the respective client devices. The method enables communication of messages between client devices based on the respective locations.

Yet another embodiment of the invention is a computer readable substrate having a computer program saved thereupon. The computer program includes steps of relating a first location to a first client device and relating a second location to a second client device. The program enables messaging communication between the first client device and the second client device because of the steps of relating.

### BRIEF DESCRIPTION OF THE DRAWINGS

The present invention is illustrated by way of example and not limitation in the accompanying figures, in which like references indicate similar elements, and in which:

FIG. 1 illustrates a wireless application service provider (ASP) system; and

FIG. 2 illustrates a group messaging system according to embodiments of the present invention;

FIG. 3 illustrates a method of operation of a wireless ASP server computer of the group messaging system of FIG. 2 for location of a communications device of the system;

FIG. 4 illustrates a co-processor device operable with a computer, according to embodiments of the present invention;

FIG. 5 illustrates a possible embodiment of the co-processor device of FIG. 4, embedded in a wireless CDPD modem;

FIG. 6 illustrates another possible embodiment of the co-processor device of FIG. 4, which is an independently packaged card or plug-in to the computer;

FIG. 7 illustrates a method of operation of an accelerating co-processor for use in enhancing and expanding capabilities and operations of client devices in a network, such as a wireless ASP system, according to embodiments of the invention;

FIG. 8 illustrates a method of operating a dynamic protocol dictionary between a client and server of a network, such as a wireless ASP system, according to embodiments of the present invention;

FIG. 9 illustrates a method for cache synchronization and operation in clients and servers of a communications network, such as a wireless ASP system, according to embodiments of the present invention.

### DETAILED DESCRIPTION OF PREFERRED EMBODIMENTS

Wireless ASP

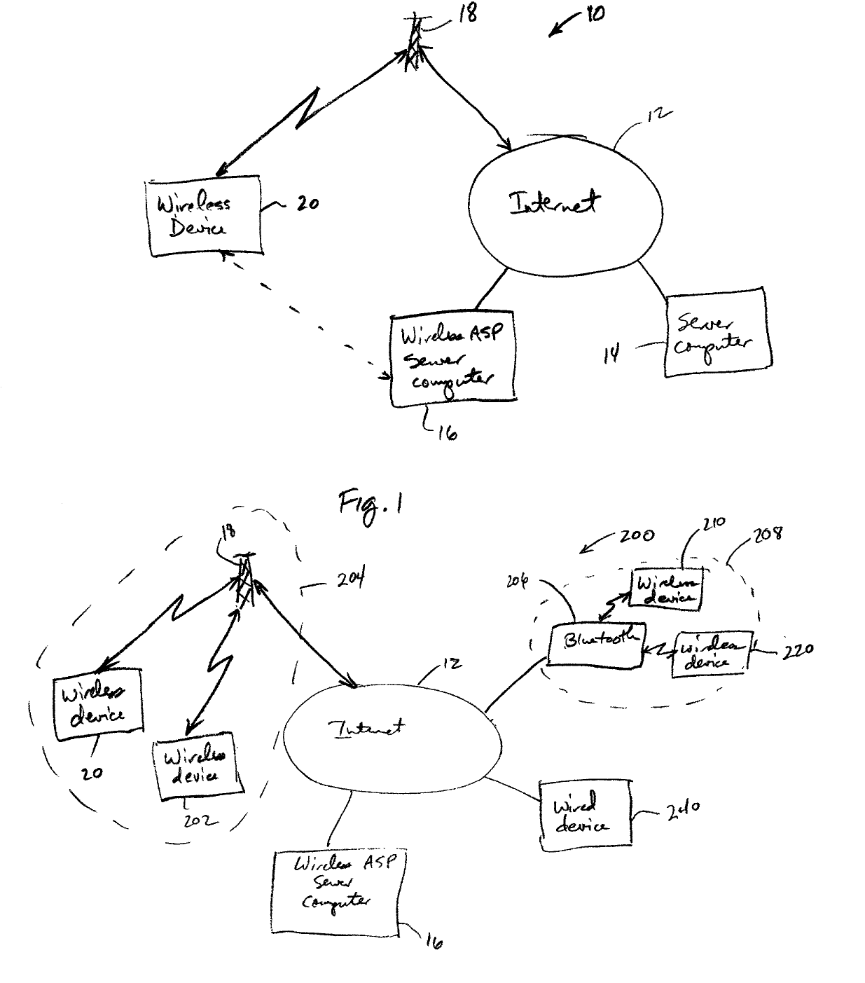

Referring to FIG. 1, a system 10 serves as a wireless application service provider (ASP). The system 10 includes a network, such as the Internet 12. The network is operable according to a packetized data protocol, such as transport control protocol/Internet protocol (TCP/IP) or some other network protocol. The network, such as the Internet 12, interconnects various computing and communications devices, for example, among other devices, a server computer 14 and a wireless ASP server computer 16. The server computer 14 and the wireless ASP server computer 16 are each one or more server computers including a microprocessor, memory storage, and communications capabilities via wire or wireless connection with the Internet 12. The server computer 14 and the wireless ASP server computer 16 communicate over the Internet 12 or other network via the protocol of the network.

The network, such as the Internet 12, is also connected with a wireless communications service provider 18. The wireless communications service provider 18 is, for example, a cellular or other packetized data wireless communications network. The wireless service provider 18 connects by wire connection with the network, such as the Internet 12. Alternatively, the wireless communications service provider 18 could connect with the network 12 by other communications connection, such as fiber optic, coax cable, wireless channel, or other communications connection. Furthermore, although the wireless communications service provider 18 is illustrated as a single particular communications channel, multiple links and multiple channels of those links, for example, communications links of wired and wireless channels, can alternatively provide the same functions and are included for purposes of the description.

The wireless service provider 18 is capable of communicating through wireless channels with various devices, such as a wireless device 20. The wireless device 20 is a processing device, such as a data-enabled cellular telephone, a personal digital assistant, a laptop computer, or any of a wide variety of other processing devices that can wirelessly communicate with the wireless service provider 18. Of course, the wireless device 20 includes communications equipment for accomplishing the wireless communication with the wireless service provider 18, such as wireless modem.

The wireless device 20 communicates through the wireless service provider 18 and over the network, such as the Internet 12, with the wireless ASP server computer 16. The wireless ASP server computer 16 serves as a dedicated server for the wireless device 20 in its communications. The wireless ASP server computer 16 sends and receives communications to and from the wireless device 20 over the network, such as the Internet 12, and on through the wireless service provider 18. The wireless ASP server computer 16 also communicates over the network, such as the Internet 12, with other network connected devices, such as the server computer 14, via protocols in communications channels enabled for such communications on the network. In certain embodiments, for example, the wireless ASP server computer 16 and the wireless device 20 communicate with specialized protocols, such as optimized packetized data protocols, for example, optimized TCP/IP protocols or other protocols such as described in the related patent applications.

Group Messaging

Referring to FIG. 2, a group messaging system 200 includes elements of the wireless ASP system of FIG. 1. The group messaging system 200 additionally details other communications devices of the system 200. For example, the group messaging system 200 includes a wireless device 202 within the same communications cell 204 of the wireless service provider 18 as the wireless device 20. The wireless device 202 is communicatively connected by wireless channel to the wireless service provider 18, and the wireless service provider 18 is communicatively connected with the Internet 12.

The group messaging system 200 also includes various other elements, such as, for example, a Bluetooth™-enabled hub 206 that is communicatively connected to the Internet 12. The hub 206 has a communication zone 208 within which Bluetooth™-enabled wireless devices, such as a wireless device 210 and a wireless device 220, can communicate wirelessly with the hub 206 and each other.

The group messaging system 200 also includes various other communications devices capable of communicating over the Internet 12, such as a wired device 240. The particular devices and elements of the group messaging system 200 which are illustrated in FIG. 2 are not exclusive or exhaustive, and are intended merely as examples of communicatively connected devices and elements that can comprise the group messaging system 200. It is to be understood that other communications devices, capable of communicating over networked channels through packetized data transmissions and receptions, are included in and can form the system 200.

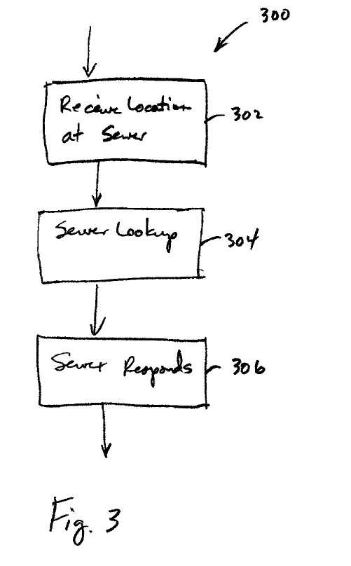

Referring to FIG. 3, in conjunction with FIG. 2, a method 300 is performed by the group messaging system 200. After each of the wireless and wireless devices 20, 202, 206, 210, 220, 240 is enabled for communications over the wireless ASP system 10 (shown in FIG. 1), for example, as described in the related patent applications, each of the devices 20, 202, 206, 210, 220, 240 makes available to the wireless ASP server computer 16 an indicator of the location, geographic or otherwise, of the particular device. The wireless ASP server computer 16 has an identifier for each of the devices 20, 202, 206, 210, 220, 240 by virtue of initiation of communications over the wireless ASP system 10 according to the particular communications protocols and data formats of the system 10. The identifier is, for example, obtained in hand-shaking protocols and procedures for each device 20, 202, 206, 210, 220, 240 with the system 10. Because each device is identifiable and also makes available the indicator of location for the particular device, the wireless ASP system 10, via storage and processing at or accessible by the wireless ASP server computer 16, can know the location of each particular device.

In the method 300 of the group messaging system 200, each device 20, 202, 206, 210, 220, 240 makes available to the server 16, in a step 302, a “location” of the respective device. The particular information or data that is the “location” of the respective device is either actively obtained by the server 16 or passively received by the server 16. The term “location” as used herein, for purposes of the group messaging system 200, is any of a wide variety of indicators regarding one or more characteristic, state or geographic location of the respective device. For example, the wireless devices 20, 202 are locatable geographically through knowledge of the particular communications cell 204 in which the devices 20, 202 are geographically located; the wireless devices 210, 220 are locatable geographically through knowledge of the particular type, identity, or geographical location of the Bluetooth™-enabled hub 206 in which communication zone 208 the devices 210, 220 are geographically located; and the wired device 240 is locatable geographically through knowledge of the particular path of connection to the Internet 12, such as, for example, identity or knowledge of the particular location of the dial-up networked server computer of the Internet 12 through which the wired device 240 accesses the Internet 12 or otherwise. Of course, various devices and various communications channels will each have unique location characteristics that can be used by the wireless ASP server computer 16. Moreover, the particular information which is the “location” can include geographic locators, message readiness indicators, availability signals, willingness to communicate states, desired query categories, and others according to the particular context of the “location” information and use.

Continuing to refer to FIG. 3, the server 16, in the step 302, can actively obtain the location for the particular device or can passively receive the location for the particular device. In the case of an active server performing the step 302, the server 16 can communicate to the particular device a request for information of the location. In such instance, the device can respond to the server 16 with the information complete the step 302. Alternatively, the server can perform the step 302 in a passive manner by processing information received from the particular device in hand-shake or other communications in order to derive the location. An example of such passive manner of performing the step 302 can include receipt by the server 16 as part of a data packet communicated by the particular device of a header or data signal that is indicative of the location. In cellular data communications, for example, the particular communications cell in which the device is located at each communication transmission can include data indicative of the cell, tower, or other physical or virtual element involved in the communication and such data can be used at the server 16 to derive the location. With cellular data communications, triangulation or other geographical positioning can be employed in appropriate applications.

Alternatively, and although not detailed herein, global positioning systems (GPS) can be employed at the device of the group messaging system 200 to provide geographic location. Such GPS data is made available to the server 16 and is processed and handled in similar manners to those described here in order to enable the group messaging here described.

After the step 302, the wireless ASP server 16 performs a manipulation of the location for the device 20, 202, 206, 210, 220, 240 in a step 304. An example of the manipulation of the step 304 is storage of the location in a correspondence table in which an identifier of the device corresponds with the location. In the step 304, the server 16 can perform a lookup of the identifier for the device and interpret the corresponding location for the device. Once the device is identified and its location is determined by the server 16, the server 16 can perform additional actions in a step 306.

In the step 306, the wireless ASP server computer 16 can perform a wide variety of activities, according to the desired application and function of the group messaging system 200. Certain examples of the activities of the step 306 include sorting and delivery by the server 16 to the device over the Internet 12 of various location-specific data. Because the device can be mobile and can be located in any variety of geographic locales throughout the world at any time, the server 16 can communicate to the device, by virtue of knowledge of the location for the device, content viewable at the device that is geared or directed to the particular location, such as local city, state, or other geographic information. Other examples of the activities of the step 306 include making the location available for use by other system 200 users. A user in a particular locale can be made available for messaging communications with other users in the locale, such as instant messaging, ICQ, e-mail, peer-to-peer, or other communications. Moreover, the location information can be indicative of other than geographic whereabouts, such as the location can indicate desired content or information of communications or desired communications, can be an availability or accessibility indicator, or can indicate desired or likely desirable application programs or services which can be made available to the particular user by the ASP. In effect, the group messaging system 200 and the method 300 allow some particular characteristic of the remote device, such as geographic location of the device or other, to be used or useable by the wireless ASP server computer 16 of the system 200 for providing ASP application programs and services, such as messaging, to the device in a device-tailored manner.

Accelerating Web Co-Processor

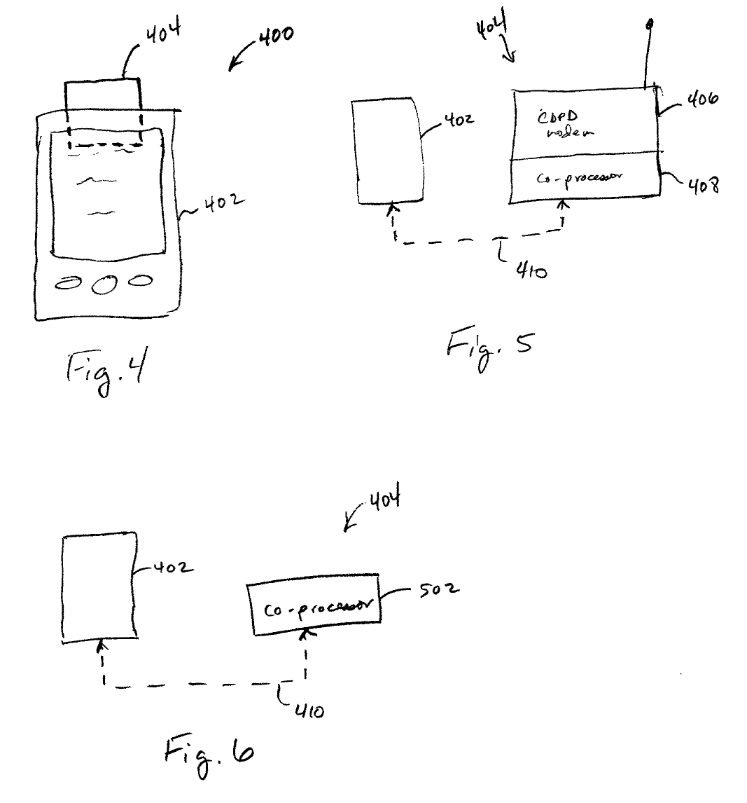

Referring to FIG. 4, a communications device 400 comprises a computer 402 and a co-processor module 404. The computer 402 is any microprocessing device that includes processing and memory functions, such as a personal digital assistant, for example, a Palm™, Handspring™, or Windows CE™-based device, a notebook computer, a processor-equipped cell phone, and any other similar device. Connected to a bus of the computer 402 is the co-processor module 404. The connection of the co-processor module 404 to the bus of the computer 402 is accomplished with a plug-in slot of the computer 402, for example, in a plug-in or card slot which accesses the bus of the computer402.

Such a co-processor module 404 includes a digital signal processor (DSP) to enhance processing capabilities and capacity of the computer 402. The DSP of the co-processor module 404 can serve a variety of functions and operations, such as, for example, supplying added encryption/decryption, communications, protocol handling, and location (e.g., global positioning system calculations) capabilities, among others. The co-processor module 404 is particularly suited for enabling and enhancing operations of the computer 402 according to the protocols and ASP services systems and methods of the related patent applications.

Referring to FIG. 5, a possible embodiment of the co-processor module 404 is a co-processor device 408, such as a DSP, embedded in a wireless modem 406 operable with the computer 402. The co-processor device 408 is connected to the modem 406 and a bus 410 of the computer 402. In the embodiment, the AT cmd 1/F & PPP signals must pass through the co-processor device 408 so that the modem 406 and computer 402 commands and control signals are communicated therebetween. In effect, the embodiment complicates the software of the computer 402 and the modem 406, somewhat, because the PPP link connection must continue to run between the computer 402 and the modem 406.

Referring to FIG. 6, an alternative embodiment of the co-processor module 404 is an independent co-processor device 502, such as a separately packaged DSP that plusuch gs in to a slot of the computer 402. In the embodiment, the co-processor device 502 is a separately packaged chip that can plug-in to the slot of the computer 402. The co-processor device 502, because separately configured from any modem or other elements, communicates only with the computer 402 by receiving signals, performing processing, and responding with signals to the computer 402.

HTML Page Prioritization

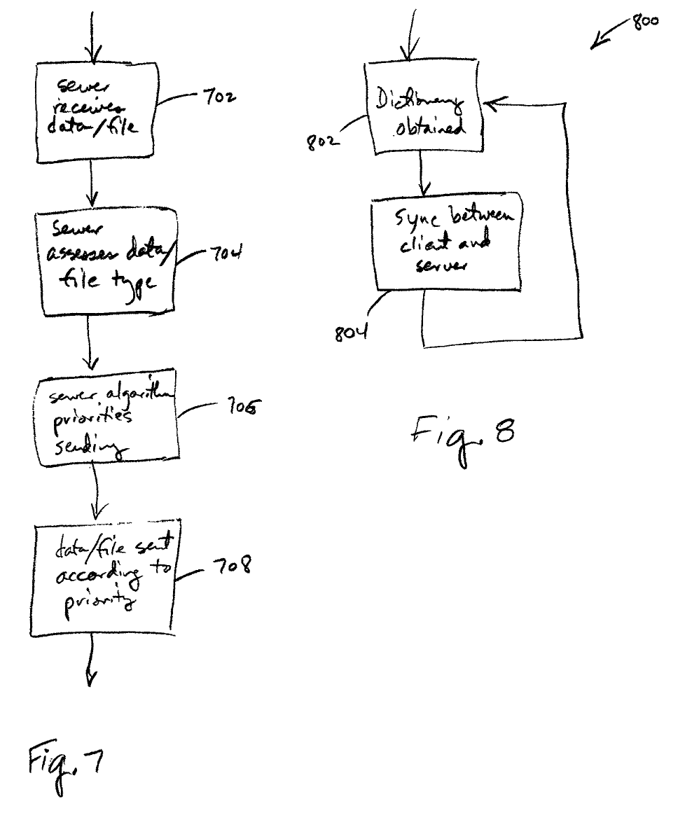

Referring to FIG. 7, a method 700 prioritizes communications of different data and file types in a wireless ASP system 10 such as that of FIG. 1. The method 700 is performed at, by or through the wireless ASP server computer 16. The method 700 commences in a step 702 of receiving by the server of data files, such as various data file types which make up an Internet web page, e.g., text, gif, jpg and other files. Once the server 16 receives data files in the step 702, the server 16 parses the data files and determines the data or file type in a step 704. The parsing and determination of the step 704 are performed as desired for the particular application and type of data. In certain embodiments, a client device that communicates with the server 16 over a network, such as the Internet, requests files or information, for example, a particular web page, and the client device dictates the particular parsing and determination made by the server 16. Such dictation by the client device can be achieved by specification of a user at the client device, type or nature of the client device, pre-programmed instructions and algorithms of the server 16, or other possibilities.

After the step 704, the server 16 prioritizes the various data and file types in a step 706. The prioritization of the step 706, like the parsing and determination of the step 704, is performed as desired for the particular application and type of data, as well as for the certain communications channels involved in the client-server communications. If the communications channels include wireless, for example, then the prioritization step 706 can include, as an example, discarding of certain data or files, sequential ordering of data and file type priorities, interrupted or intermittent prioritizations, on the fly prioritization based on rules regarding communications channel conditions and constraints, and numerous others.

A step 708 of transmitting data or files is performed by the server 16 to the client device over the communications channels of the network. The transmissions of the step 708 are made according to the prioritization from the step 706. In this manner, the server 16 transmits data to the client devices in a prescribed order, sequence, or other arrangement. The prioritized transmissions can better optimize channel usage, provide an appearance of added communications speed at the client device by allowing display or other use of certain matters sooner or later than others, dispense with or delay undesirable or less desirable information relative to other information, and many other similar possibilities.

Other Prioritization:

In addition to the content-based prioritization of communications, as just described, other bases for prioritization of communicated information can be employed separately or in conjunction with the method 700 or system 10. Particularly, a wide variety of schemes of prioritization according to content type can be employed, however, priority of (1) HTML, (2) gif (3) CSS and (4) js, in that particular sequence of transmission according to data type, has been determined to work well in wireless transmissions, such as in the system 10. Of course, this particular sequence of priority as to data types transmitted is not absolute or necessary, and other sequences of prioritization can be appropriate or desirable according to all circumstances of the system 10 and its operations.

Moreover, content-based prioritization of communication transmission sequence can be employed together with priority schemes for transmissions based on other factors. For example, within each category or type of data, additional prioritization of transmissions can be based on size (i.e., quantity) of data of the respective types. In the case of data-size prioritization, larger quantities of data within each data type can have a lower priority in transmission sequence. Thus, within particular data types of the sequence, further prioritization is achieved by sending smaller quantity data items with priority over greater quantity data items.

In operation of the system 10 using these other prioritization schemes for communications, more share of transmission capacity is afforded to higher priority items. This does not necessarily require that items of higher priority be exclusively transmitted before items of lower priority, however, it does mean that the elements of the system 10, such as the wireless device 20 and the wireless ASP server computer 16, will include programming that effects prioritization according to desired schemes for the transmissions of communications. In certain embodiments, the system 10, or its elements, as the case may be, can make determination about the number of different items for communication and then apportion the sending and transmission channels and capacity according to a particular prioritization scheme. Such prioritization can speed transmitted communications, and can otherwise optimize usage of the system 10 for communications.

Dynamic Dictionary Protocols

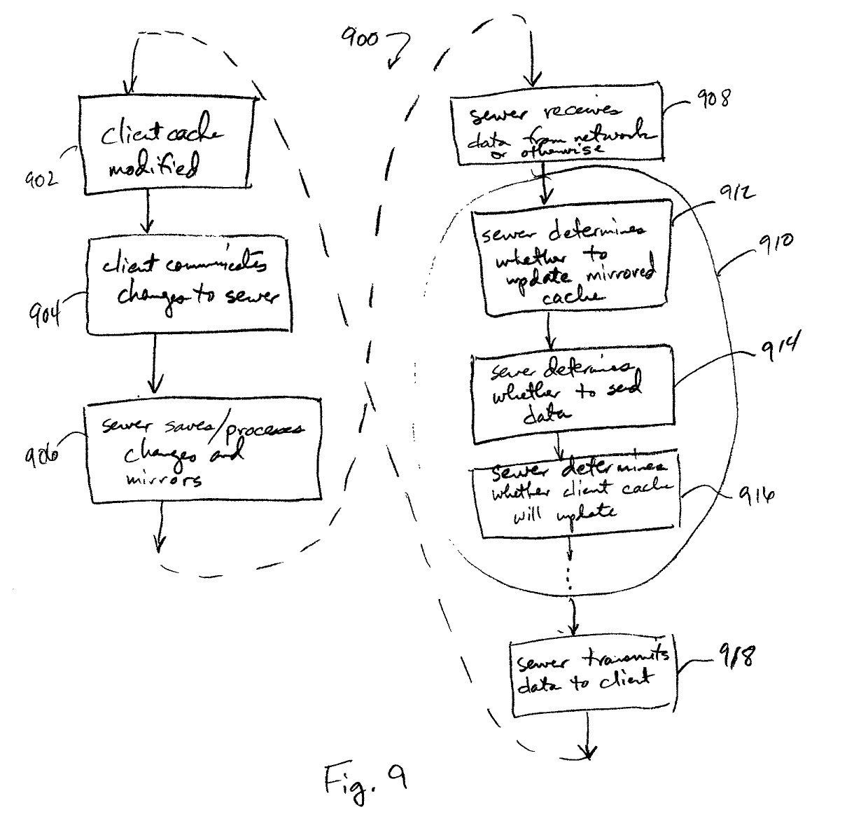

Referring to FIG. 8, a method 800 of operation of a dynamic protocol dictionary is commenced with a step 802 of obtaining the dictionary. The dynamic protocol dictionary is a database of commands, data, instructions, or other information, and sequences thereof, that are repeatedly communicated between client devices and the wireless ASP server computer 16 of the wireless ASP system 10 of FIG. 1. The dynamic protocol dictionary is generated by a user specifying the dictionary elements, by algorithmic recognition of repeated or oft-used data communications, by algorithmic derivation based on conditions or states, such as communications channel events, and any other available and desirable generation scheme.

The server 16 can maintain the dynamic protocol dictionary as a master, with the client devices as slaves, so that the dictionary at the server 16 is always the current and effective dictionary. In such instance, communications between client devices and the server 16 continually update and maintain corresponding dynamic protocol dictionary at the client devices. Alternatively, the client devices can act as masters, or the client devices and server 16 can each provide update and maintenance through communications with others.

Of course, the dynamic protocol dictionary can take any of a variety of forms of relational database residing on any or several of the devices or elements of the network, as applicable. In any event, the dynamic protocol dictionary serves to reduce the quantity of bits required in communications of signals or information, by causing devices of the network in communication to recognize terms, or data, of the dictionary as indicative of greater amounts of information or data that are merely so abbreviated for purposes of communication.

Once the dynamic protocol dictionary is obtained in the step 802, a step 804 synchronizes the dictionary between client and server devices. This synchronization of the step 804 can be performed on the fly, in real time, during communications between client and server devices, or at intermittent scheduled times, on manual command, or other periods. Once the sync step 804 occurs, the dictionary is again updated and maintained, either continuously or periodically, as applicable, as indicated by the return flow of the method 800 from the step 804 to the step 802.

Cache File Synchronization and Optimization

Referring to FIG. 9, a method 900 is performed by a client device and a server device, such as for example, the wireless client device 20 and the wireless ASP server computer 16 of the wireless ASP system 10 of FIG. 1. In the method 900, certain actions or steps are performed by the client device and other actions or steps are performed by the server. This is illustrated in FIG. 9, for example purposes, by the left-side flow diagram as client-side steps and the right-side flow diagram as server-side steps. The interaction and relationship of the client and server steps are shown in FIG. 9 in phantom arrows.

In the example of the method 900, the client-side steps include a step 902 of modifying a cache memory of the client device. The cache of the client device is modified in conventional manner, although the client device can include specialized software or hardware that limits cache reading and writing activities or that specially configures or organizes the cache in connection with the communications of the method 900. The possibilities will be understood through the further description here of the method 900 and its implications.

In a step 904, the client device communicates over the network to the server particular indicators of the changes to the cache from the step 902. The indicators that are communicated can be the changes themselves or other indicators or abbreviations, such as those possible through the dynamic protocols dictionary previously discussed herein. Upon communication of the changes or indicators in the step 904, the server then receives and recognizes the indicators and mirrors, at or through the server, the cache then-existing at the client device. The mirroring at the server is performed in a step 906, which step 906 can include memory saves, processing, selections, and other operations at or in connection with the server.

Thereafter, the server continues operations on the network, including such operations as receiving in a step 908 various data from the network that corresponds to client requests, protocols or other network signals. In a step 910, the server performs operations on data obtained in the receiving step 908, which operations include reference or comparison to the mirrored cache at the server. Numerous different operations of the server are possible in the step 910, such as, for example, the server can determine in a step 912 whether or not to update or modify the mirrored cache at the server based on how the server handles and communicates with the client, the server can determine whether or not to send data (or portions of data) to the client that is received by the server from the network or otherwise, and the server can determine whether the client cache will or will not be upon client's receipt of data to be communicated by the server. In any event, the step 910, whatever it includes, serves to limit the number of communications and the amount of information communicated between the client and server.

In a simple arrangement, for example, the server can, based on a comparison of received data from the network to the mirrored cache at the server, distinguish only such data that is modified and communicate to the client only such modified data. Because the client cache is mirrored at the server, the server can know that the client has all other unmodified data already in the client cache. This can eliminate the number of communications, and also the quantity of data, necessary to fully make available to the client all data obtained by the server from the network (i.e., in effect, by delivering only portions of the data that are changed and not already resident at the client). This is only one example that the mirroring can accomplish, as the processing capabilities of both the server and the client can be employed to manipulate data and make guesses, forward determinations, exclusion or delay of transmissions of less desirable data (e.g., exclusion from transmissions of data that is ad banners or other identifiable data types or portions of data).

After the step 910, the server transmits only appropriate data, based on the step 908 determinations, to the client. The client receives the data and the method 900 returns to the step 902 of the client. Although the method 900 is described with respect to client and server, it should be understood that any devices communicating on the network can serve client or server functions, whether or not such devices or traditionally considered client or server in the typical or other sense. In operation of the systems 10, 200, 400 and the methods 300, 700, 800, 900, numerous alternative business and technical arrangements are possible. In certain embodiments, the administrator of the wireless ASP server computer 16 can provide select interfaces and content to the wireless device 20 or other client device of the network. For example, the wireless device 20 can be equipped with a form of World Wide Web (WWW) browser that performs according to the specialized protocols for the communications between the wireless device 20 and the wireless ASP server computer 16. In such instance, the wireless ASP server computer 16 can provide to the wireless device 20 according to those same specialized protocols various data and information, including such things as graphics, images, voice, text, and other digitally represented information and matters.

The wireless ASP server computer 16 must also, however, be capable of communicating via typical network protocols with other network connected devices in order to receive and deliver messages from and to those network connected devices, and then transfer those messages on or receive those messages from the wireless device 20, as appropriate.

Although only particular devices of a communications network and its nodes are herein described and discussed, particularly, wireless devices 20, 202, the wireless ASP server computer 16, the wireless service provider 18, the server computer 14, the Bluetooth™-enabled devices 206, 208, 220, the wired device 240 and the network, such as the Internet 12, have been described with regard to the embodiments, it is to be expressly understood that combinations of those elements, such as a plurality of any, certain ones, all of those elements, and even additional or alternative elements, is possible in keeping with the scope of the embodiments herein. The network could be an intranet, or even an intranet combination or intranet-extranet combination. Numerous banks of the wireless ASP server computer 16 can be possible for receiving communications from pluralities of wireless devices, and the wireless ASP server computers can be centrally located or distributed through a wide geographic area. In the case of a global network such as the Internet, the network is capable of communicating by its protocols, which may include other specialized protocols for specific situations. The wireless ASP server computer in such instance can communicate with various devices on the network according to those other specialized protocols, if properly equipped as would be known to those skilled in the art. In general, the communications between the wireless device or devices and the wireless ASP server computer or computers occurs according to optimized protocols for wireless communications. These optimized protocols can be implemented entirely in software or alternatively can be hardware, combinations of hardware and software, or other mechanisms. The protocols of the hardware or software, as the case may be, for the wireless communications will, in any event, provide increased communications efficiency, speed, and adaptation for the wireless environment.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention.

Benefits, other advantages, and solutions to problems have been described above with regard to specific embodiments. However, the benefits, advantages, solutions to problems and any element(s) that may cause any benefit, advantage, or solution to occur or become more pronounced are not to be construed as a critical, required, or essential feature or element of any or all the claims. As used herein, the terms “comprises, “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A wireless communications network, comprising:
a wired network;
a wireless channel;
a server computer connected to the wired network;
a wireless packetized data communications provider equipment connected to the wired network;
a first client device communicatively connected via the wireless channel to the wireless packetized data communications provider, and
a second client device communicatively connected to the network.

2. The wireless communications network of claim 1, further comprising a detector for detecting a first location of the first client device and a second location of the second client device.

3. The wireless communications network of claim 2, wherein the detector is selected from the group consisting of: a software and a hardware of the server computer.

4. The wireless communications network of claim 3, wherein the first client device communicates an indicator of the first location to the server computer.

5. The wireless communications network of claim 2, wherein the wired network is the Internet.

6. The wireless communications network of claim 1, wherein the wireless channel is a cellular packetized data system.

7. The wireless communications network of claim 1, wherein the wireless channel is a CDPD system.

8. The wireless communications network of claim 1, further comprising a server software stored on the server computer for relating the first location to the first client device and the second location to the second device and for making available an information corresponding to the first location and the second location for communication over the network.

9. A method of wireless communications, wherein a first client device has a first location and a second client device has a second location, comprising the steps of:
serving a first information indicative of the first location to the second client device;
serving a second information indicative of the second location to the first client device;
enabling, by virtue of the first information and the second information, the first client device to communicate with the second client device.

10. The method of claim 9, wherein the steps of serving comprise the steps of:
performing a look-up in a relational database; and
making known the look-up result to at least one of the first client device and the second client device.

11. The method of claim 10, wherein the wireless channel communicates a message, selected from the group consisting of: text, graphic, image, voice, and streaming media.

12. A computer readable substrate having a computer program saved thereupon, the computer program comprising the steps of:
relating a first location to a first client device;
relating a second location to a second client device; and
enabling messaging communication between the first client device and the second client device because of the steps of relating.
